(19) United States
(12) Patent Application Publication
(10) Pub. No.: US 2009/0200008 A1
(43) Pub. Date: Aug. 13, 2009

(54) SYSTEM AND METHODS FOR CONSERVATION OF EXHAUST HEAT ENERGY

(75) Inventor: Phil Chandler, San Francisco, CA (US)

Correspondence Address: DUGAN & DUGAN, PC, 245 Saw Mill River Road, Suite 309, Hawthorne, NY, 10532, US

(73) Assignee: APPLIED MATERIALS, INC., Santa Clara, CA (US)

(21) Appl. No.: 12/365,164

(22) Filed: Feb. 3, 2009

Related U.S. Application Data
(60) Provisional application No. 61/026,126, filed on Feb. 4, 2008.

(51) Int. Cl. G05D 23/19; F16L 53/00

(52) U.S. Cl. 165/289; 137/335; 137/340; 165/299

(57) ABSTRACT

Methods, apparatus and systems are provided for conserving energy in an electronic device manufacturing facility. In one aspect an electronic device manufacturing system is provided including one or more process chambers; one or more abatement tools; two or more effluent conduits connecting the one or more process chambers to the one or more abatement tools; a channel adapted to house a portion of at least two of the two or more effluent conduits; and one or more heating elements adapted to heat the two or more conduits within the channel.

The present application claims priority to U.S. Provisional Patent Application Ser. No. 61/026,126 filed Feb. 4, 2008 and entitled “System and Methods for Conservation of Pump Exhaust Heat Energy” (Attorney Docket No. 12670/L) which is hereby incorporated herein by reference in its entirety for all purposes.

### FIELD OF THE INVENTION

The present invention relates to electronic device manufacturing, and more specifically to systems and methods for conserving pump and exhaust heat energy in an electronic device manufacturing facility.

### BACKGROUND OF THE INVENTION

Effluents from the manufacture of electronic materials and devices may include a wide variety of chemical compounds which are used and/or produced during manufacturing. During processing (e.g., physical vapor deposition, diffusion, etch PFC processes, epitaxy, etc.), some processes may produce undesirable byproducts including, for example, perfluorocompounds (PFCs) or byproducts that may decompose to form PFCs. PFCs are recognized to be strong contributors to global warming. These compounds, which may be harmful to the environment, may hereinafter be referred to as “harmful compounds”. It is generally desirable to remove the harmful compounds from the effluent before the effluent is vented into the atmosphere.

Harmful compounds may be removed from the effluents, or converted into non-harmful compounds and/or more easily removable compounds via a process known as abatement. During an abatement process, the harmful compounds used and/or produced by electronic device manufacturing processes may be destroyed, or converted into less harmful or non-harmful compounds (abated) which may be further treated or emitted into the atmosphere. It is common in the industry to refer to “abating effluent” when referring to “abating harmful compounds in effluent”, and “abating effluent” as used herein is intended to mean “abating harmful compounds in effluent”.

It is known that effluent may be abated in a thermal abatement reactor which heats and burns, or oxidizes, the effluent, thereby converting the harmful compounds into less harmful compounds and/or more easily scrubbable compounds. The abatement reactor may include a pilot device, a fuel supply, an oxidant supply, burner jets, and effluent jets. The pilot may be used to ignite burner jets to form burner jet flames. The burner jet flames may generate the high temperatures necessary to abate the effluent.

The effluent may travel through one or more conduits on the way to the abatement reactor from the process chambers, where the electronic devices may be processed. Additionally, the effluent may travel through other conduits after leaving the abatement reactor on the way to being further processed and/or being emitted into the atmosphere. As is well known in the art, it is desirable to heat effluent conduits to a desired temperature to prevent condensation and/or precipitation of the effluent fluid, because the condensation and/or precipitation may, for example, clog the conduits. Typically, conduits may be individually heated to achieve a temperature level that prevents condensation and precipitation of the effluent fluid. Heating each individual conduit, however, may require a significant amount of energy, which may be costly. Accordingly, a need exists for improved methods and systems for conserving energy in an electronic device manufacturing facility.

### SUMMARY OF THE INVENTION

In aspects of the invention, an electronic device manufacturing system is provided including one or more process chambers; one or more abatement tools; two or more effluent conduits connecting the one or more process chambers to the one or more abatement tools; a channel adapted to house a portion of at least two of the two or more effluent conduits; and one or more heating elements adapted to heat the two or more conduits within the channel.

In other aspects, a system adapted to conserve energy in an electronic device manufacturing facility is provided including one or more processing tools adapted to process an electronic device; one or more abatement systems adapted to abate effluent flowing from the one or more processing tools; an apparatus adapted to couple the one or more processing tools to the one or more abatement systems, wherein the apparatus includes: two or more co-located effluent conduits carrying effluent fluid between the one or more abatement systems and the one or more processing tools; and a shared heating source adapted to supply heat to the two or more co-located effluent conduits.

In yet other aspects a method for conserving energy in an electronic device manufacturing facility is provided, including the steps of: providing one or more abatement systems adapted to abate effluent fluid from two or more process chambers of one or more process tools; providing two or more co-located effluent conduits between the two or more process chambers and the one or more abatement systems, with at least one effluent conduit being attached to each of the two or more process chambers; and flowing the effluent fluid in the two or more co-located effluent conduits between the two or more process chambers and the one or more abatement systems; and subjecting the two or more co-located effluent conduits to heating by a shared heat source.

Other features and aspects of the present invention will become more fully apparent from the following detailed description, the appended claims and the accompanying drawings.

### BRIEF DESCRIPTION OF THE FIGURES

FIG. 1 is a schematic illustration of a prior art system.

FIG. 2 is a schematic illustration of a system for conserving heat energy in accordance with an embodiment of the present invention.

FIG. 3 is a schematic illustration of an apparatus for conserving heat energy in accordance with an embodiment of the present invention.

FIG. 4 is a schematic illustration of an apparatus for conserving heat energy in accordance with an embodiment of the present invention.

FIG. 5 is a flowchart illustrating an exemplary method for monitoring the heat in a channel in accordance with an embodiment of the present invention.

FIG. 6 is a schematic illustration of a system for conserving heat energy in accordance with an embodiment of the present invention.

FIG. 7 is a cross sectional view along section line 7-7 of FIG. 6 of a shared heating source in accordance with an embodiment of the present invention.

FIG. 8 is a flowchart illustrating an exemplary method for conserving energy in accordance with an embodiment of the present invention.

### DETAILED DESCRIPTION

The present invention may be used to efficiently heat more than one effluent conduit in an electronic device manufacturing facility. In some embodiments of the present invention, the effluent (exhaust) conduits may be co-located and may be subjected to a shared heating source. In other embodiments, two or more conduits may be placed in an enclosed channel and the conduits may be heated together (e.g., by convection or conductive methods as will be further described below). The conduits may be maintained within selected temperature ranges to prevent the formation of condensation and/or particulates which may be hazardous and/or which may clog the conduits themselves, pumps, and other ancillary equipment.

Before the present invention, conduits have typically been heated and insulated individually. Significantly more heat and energy may be needed to heat conduits individually than may be needed to heat multiple conduits which are co-located (e.g., located close to or next to each other). Even less energy may be needed when multiple conduits are co-located in an enclosed area in which a heater can be shared by the conduits. The present invention may also include a controller and/or sensors. The sensors may be adapted to sense the temperature of the effluent flowing through the effluent conduits and/or the temperature of an ambient atmosphere within the enclosed area. The controller may be adapted to receive signals indicative of the temperature of the effluent in the effluent conduits and/or the ambient atmosphere within the enclosed area, and may be further adapted to determine whether more heat should be supplied to the effluent in order to prevent condensation and/or precipitation. The controller may be further adapted to control heat sources were the heat sources are adapted to provide heat to the effluent. The controller may control the heat sources based on feedback received from various types of sensors or other information sources that may be coupled internally or externally to the individual conduits or to the enclosed channel, or, in some embodiments, to the processing tools.

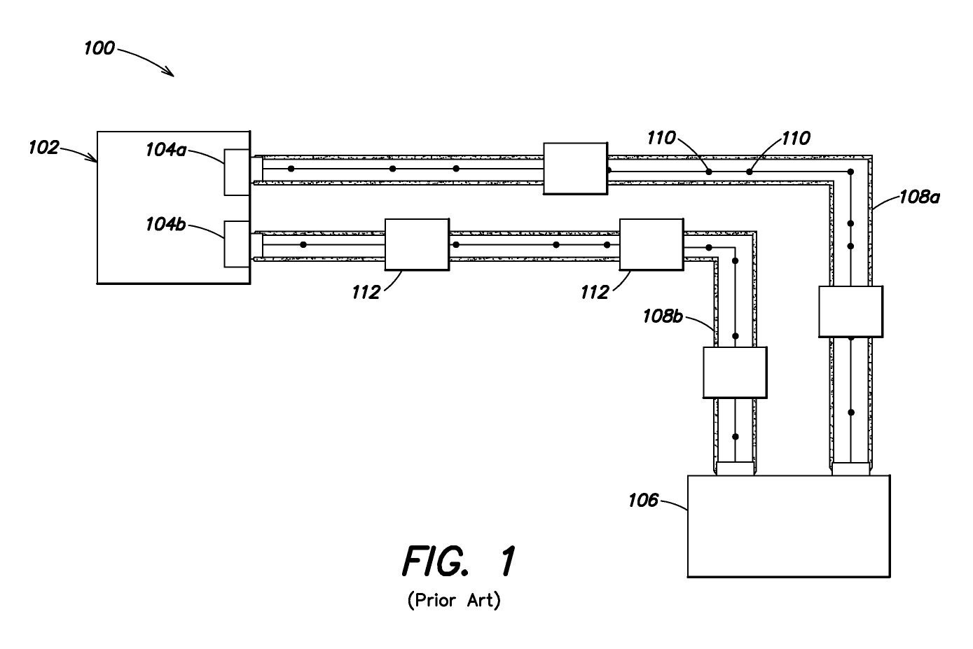

Turning to FIG. 1, a schematic illustration of a system 100 as used in the prior art is depicted. The system 100 may include a processing tool 102 including two or more process chambers 104a-b. Each process chamber 104a-b may be coupled to an abatement system 106 via a conduit 108a-b. The conduits 108a-b may include one or more heating elements 110. The heating elements 110 may be, for example, one or more resistance wire heater elements in one or more silicon mats wrapped around the conduits 108a-b, or may be any other suitable heating elements positioned along the length of the conduits 108a-b and adapted to maintain the effluent at a sufficient temperature to resist condensation to liquid. For example, in a conduit 108a-b which is 15 feet long, there may be about 10-20 heating elements 110 coupled to the conduits 108a-b. The heating elements 110 may be placed at intervals that may be evenly or unevenly spaced. The system 100 may also include one or more pumps 112 positioned along the length of the conduits 108a-b to facilitate the flow of the effluent through the conduits 108a-b. The conduits 108a-b may be made from stainless steel or any other suitable material which is resistant to corrosion and/or clogging. The conduits 108a-b may be insulated, as indicated by the thick black line outlining the conduits 108a-b.

As is well known in the art, during the operation of electronic device process chambers 104a-b of the processing tool 102, effluent may be created which may contain undesirable compounds and therefore may require abatement. Effluent may flow from the process chambers 104a-b through the conduits 108a-b and into a reaction chamber (not shown) of the abatement system 106 for abatement. The pumps 112 may facilitate the flow of effluent through the conduits 108a-b, and the pumps 112 may impart some heat to the effluent. The pump heat may typically not be enough, however, to prevent condensation and precipitation in the conduits 108a-b. As effluent flows through the conduits 108a-b, the conduits 108a-b may be individually heated by the one or more heating elements 110, and may be individually insulated, as is well known in the art. The heating elements 110 may be self-regulated, and shut themselves off when a certain temperature is reached. As described above, keeping the conduits 108a-b at a desired temperature may prevent the formation of condensation and precipitates, thereby preventing the clogging of the conduits 108a-b, the pumps 112 used to facilitate effluent flow, and the other ancillary equipment. This may require a significant amount of energy.

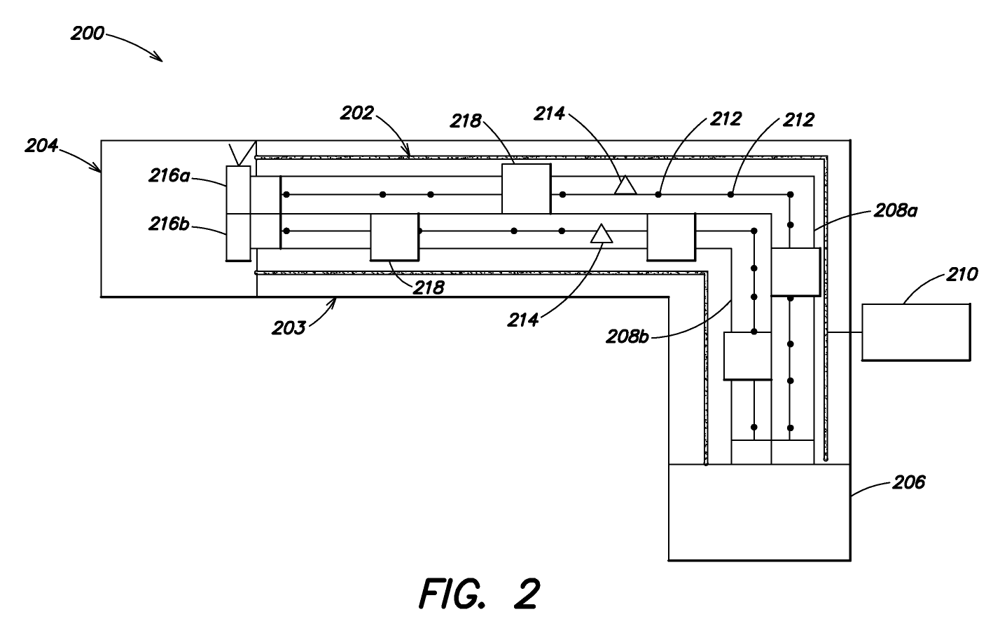

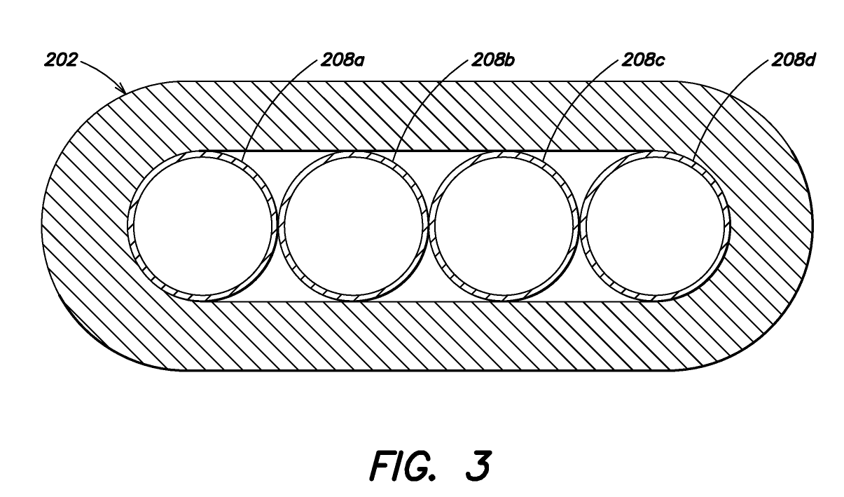

Turning to FIGS. 2 and 3, a schematic illustration of a system 200 for conserving heat energy in accordance with an embodiment of the present invention and a cross-sectional view of an inventive channel 202, respectively, are depicted. The system 200 shown in FIG. 2 may be similar to the system as shown and described above with respect to FIG. 1, with the exception that the system 200 shown in FIG. 2 may include the channel 202 which may be housed, for example, in a mainframe 203. The mainframe 203 and channel 202 may couple a processing tool 204 to an abatement system 206, wherein the channel 202 may be adapted to house two or more conduits 208a-b. The system 200 may also include a controller 210 coupled to the channel 202 and adapted to monitor the heat energy level in the channel 202 and/or the conduits 208a-b. Accordingly, only the inventive channel 202 and controller 210 are described with reference to FIGS. 2 and 3.

The conduits 208a-b, shown in FIGS. 2 and 3, may be in contact with each other and surrounded by the channel 202. In some embodiments, the channel 202, instead of the conduits 208a-b, may be insulated. As will be further described below, if the conduits 208a-b are individually insulated, the insulation may impede heat transfer between the conduits 208a-b. In some embodiments the one or more heating elements 212 may be, for example, one or more resistance wire heater elements in one or more silicon mats wrapped around the conduits 208a-b, thereby heating the conduits 208a-b by conduction and/or radiation. Other suitable heating elements 212 may be used. In another embodiment, the heating elements 212 may be positioned along the length of the channel 202, but not in contact with the conduits 208a-b, thereby heating the atmosphere surrounding the conduits 208a-b. In this embodiment the conduits 208a-b may be heated by convection and/or radiation. In another embodiment, the heating elements 212 may be positioned both along the length of the channel 202, e.g., not in contact with the conduits to 208a-b, and also along the length of and in contact with the conduits 208a-b, thereby convectively, radiatively and conductively heating the conduits 208a-d and the effluent therein. Other heating element 212 configurations and methods may be used. By having the conduits 208a-b in contact with each other, regardless of the position of the heating elements 212, heat may be transferred between the conduits 208a and 208b which may have a temperature equalizing effect between conduit 208a and conduit 208b. Additionally, by housing the conduits 208a-b in the channel 202, the ambient heat from the individual conduits 208a-b may be transferred efficiently among the conduits 208a-b, as the ambient heat is contained within the channel 202. The channel 202 may also contain the ambient heat from the pumps 218, thereby minimizing the radiant heat losses.

The channel 202 may also include one or more sensors 214 positioned within the channel 202. The sensors 214 may, for example, detect the temperature within the channel 202. The sensors 214 may also be coupled to, or positioned within, the conduits 208a-b, for example, to detect the temperature in a particular conduit 208a-b. The controller 210 may receive one or more signals from the sensors 214 which may be indicative of the temperature in the channel 202 and/or of the temperature of the effluent in the conduits 208a-b. The controller 210 may also be hardwired or wirelessly coupled to the heating elements 212 and may be adapted to control the heat provided by the heating elements 212. In some embodiments the controller 210 may control the heating elements 212 to control the heat, based on, for example, feedback received from the sensors 214, as will be further described below. In other instances, the controller 210 may control the heating elements 212 to control the heat, based on information about the effluent (e.g., composition, volume) received from the processing tool 204 or from the sensors 214 positioned downstream of the processing tool 204. The controller 210 may be a microcomputer, a microprocessor, a logic circuit, a combination of hardware and software, or the like. In some embodiments, the channel 202 may include access ports and/or panels (not shown) that may be operable to be opened or removed to enable maintenance of the conduits 208a-b, the heating elements 212, the sensors 214, and/or the controller 210.

In operation, the process chambers 216a-b of the process tool 204 may process one or more substrates, thereby creating effluent as a byproduct. The effluent may flow from the process chambers 216a-b through the one or more conduits 208a-b to the abatement system 206, for example. As described above, the pumps 218 may facilitate the movement of the effluent through the conduits 208a-b. The pumps 218 may be, for example, mechanical dry pumps, or any other suitable pumps.

As the effluent flows through the conduits 208a-b, the effluent may be heated in the conduits 208a-b by the heating elements 212. The heating elements 212 may be controlled by the controller 210 to provide, for example, a particular magnitude of heating to attain a desired temperature range. The desired temperature may be a temperature which prevents condensation and/or precipitation in the conduits 208a-b. The desired temperature may be based on, for example, the composition and volume of the effluent. As described above, the channel 202 may enable the desired temperature to be more easily achieved and/or maintained by providing an environment in which the thermal energy/heat may be shared by or transferred among conduits 208a-b.

In the foregoing and other embodiments, the heating elements 212 may be controlled by the controller 210 such that a desired temperature is maintained in the channel 202 and/or in the conduits 208a-b. For example, if the sensors 214 send a signal to the controller 210 indicative of a temperature below the desired temperature, the controller 210 may send a signal to the heating elements 212 to increase the level of heat produced until the desired temperature is met. In some embodiments, the controller 210 may maintain one temperature when effluent is flowing in the conduits 208a-b and a second temperature (e.g., a lower level) when one or more of the conduits 208a-b are not flowing effluent. Thus, the system may be operated more efficiently by only heating the channel 202 when necessary to prevent the formation of condensation and/or precipitation in the conduits 208a-b. In such embodiments, the system may include one or more sensors to detect that effluent is flowing in the conduits 208a-b. Likewise, different effluent types may require different levels of heat to prevent the formation of condensation and/or precipitation in the conduits 208a-b. The present invention may use sensors to detect the effluent type and provide an appropriate level of heat which may be necessary to prevent condensation and/or precipitation.

In one embodiment, shown in greater detail in FIG. 3, conduits 208a-d may be arranged in-line and housed within the channel 202. Other configurations of conduits 208a-d may be used. As described above with respect to FIG. 2, the heating elements 212 may be positioned along the length of the interior or exterior of the channel 202. The configuration of the heating elements 212 may enable the atmosphere surrounding the conduits 208a-d within the channel 202 to be heated, and the heated air may in turn transfer heat to the conduits 208a-d and the effluent flowing therein. Alternatively, the heating elements 212 may be positioned at intervals along the length of the conduits 208a-d. This configuration of heating elements 212 may enable the heating elements 212 to contact the conduits 208a-d and thereby impart heat to the conduits 208a-d by conduction, which may in turn heat the effluent flowing therein. The heat may also be transferred between the individual conduits 208a-d. Regardless of the positions of the heating elements 212 and the method of heating (conduction and/or convection), the channel 202 may enable the ambient heat emanating from the heating elements 212 and/or conduits 208a-d to be contained within the channel 202 and thereby be shared by the conduits 208a-d. In this manner, heat energy may be conserved, as this ambient heat may be used to achieve and/or maintain the temperature thresholds used to prevent and/or reduce the condensation and/or precipitation of effluent in the conduits 208a-d.

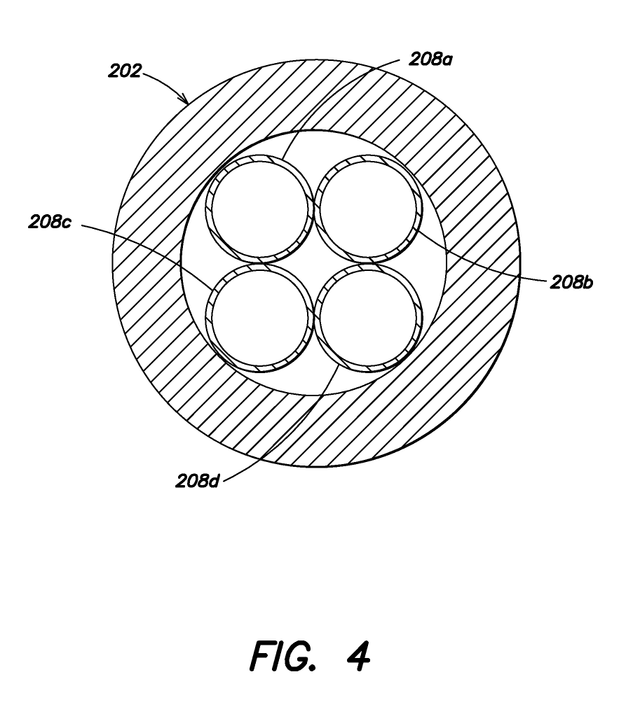

Turning to FIG. 4, an exemplary schematic illustration of a conduit 208a-d configuration of the present invention is depicted. While the conduits 208a-d depicted in FIG. 3 were arranged in-line, the conduits 208a-d may alternatively be configured in a stacked box orientation such as shown in FIG. 4. Any suitable conduit 208a-d configurations may be used. The channel 202, conduits 208a-d, controller 210 and other features described above with respect to FIGS. 2 and 3 apply equally to the channel 202 shown in FIG. 4. Accordingly, only the conduit 208a-d arrangement is described with reference to FIG. 4. The stacked box arrangement of the conduits 208a-d may enable a more efficient use of heat than the in-line arrangement described above with respect to FIG. 3. For example, in the stacked box configuration, the ambient heat may be more concentrated, because the heat may not be dispersed over as wide an area as with the conduit 208a-d in-line configuration. Additionally, with the conduits 208a-d in the stacked box configuration, the heat may be more easily shared among conduits 208a-d as each conduit 208a-d may be in contact with and/or closer to more conduits 208a-d than the in-line configuration in FIG. 3. For example in the in-line configuration shown in FIG. 3, conduit 208a is in contact with only conduit 208b. In the stacked box configuration in FIG. 4, on the other hand, conduit 208a is in contact with both conduits 208b and 208c. The additional contact points for conduit 208a may enable, for example, conduit 208a to receive heat directly from both conduits 208b and 208c and therefore conduit 208a may be heated more efficiently than if conduit 208a were only in contact with 208b. Other conduit 208a-d configurations may be used. The stacked box configuration of FIG. 4 may also enable partial or complete equalization of the temperatures of the effluents in conduits 208a-d.

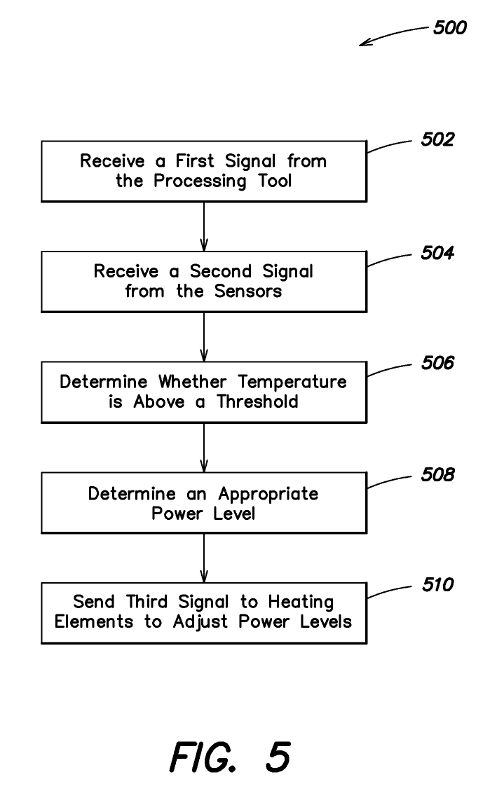

Turning to FIG. 5, a flowchart illustrating an exemplary method 500 for monitoring the temperature of a channel, such as channel 202 of the preceding FIGs., is depicted. In step 502, a controller may receive a first signal from a process tool. The first signal provides information about effluent flowing from the process tool to an abatement tool through one or more conduits, which are housed within a channel. The information may, for example, indicate the type and/or amount of effluent flowing from the process tool. In step 504, a second signal is received from one or more sensors coupled to the channel. The second signal may indicate a temperature in the channel. Alternatively it's a second signal may indicate a temperature of effluent in the conduits. A determination is then made as to whether the temperature in the channel is above or below a predetermined temperature in step 506. The determination may be made via an algorithm, for example. The algorithm may be used to compare the temperature in the channel to the temperature which has been predetermined for an amount and type of a particular effluent then flowing. This predetermined temperature may be stored, for example, in a database that may be accessed by the algorithm. Then, in step 508, based on the temperature determination of step 506, a determination may be made regarding the power to supply to the one or more heating elements that are configured to heat the one or more conduits. For example, if it is determined in step 506 that the measured temperature is sufficient, the power level then applied may be maintained in step 508. If, for example, it is determined in step 506 that the temperature is below the pre-determined temperature, a decision may be made in step 508 to increase the power supplied to the one or more heating elements. Alternatively, if it is determined in step 506 that the temperature is too high, a decision may be made in step 508 to decrease the power supplied to the one or more heating elements. After the power level determination is made in step 508, a third signal may be sent to the heating elements to adjust or maintain the power levels thereof accordingly in step 510. In this manner, the heat energy may be conserved and used more efficiently. Following step 510, method 500 may loop back to step 502.

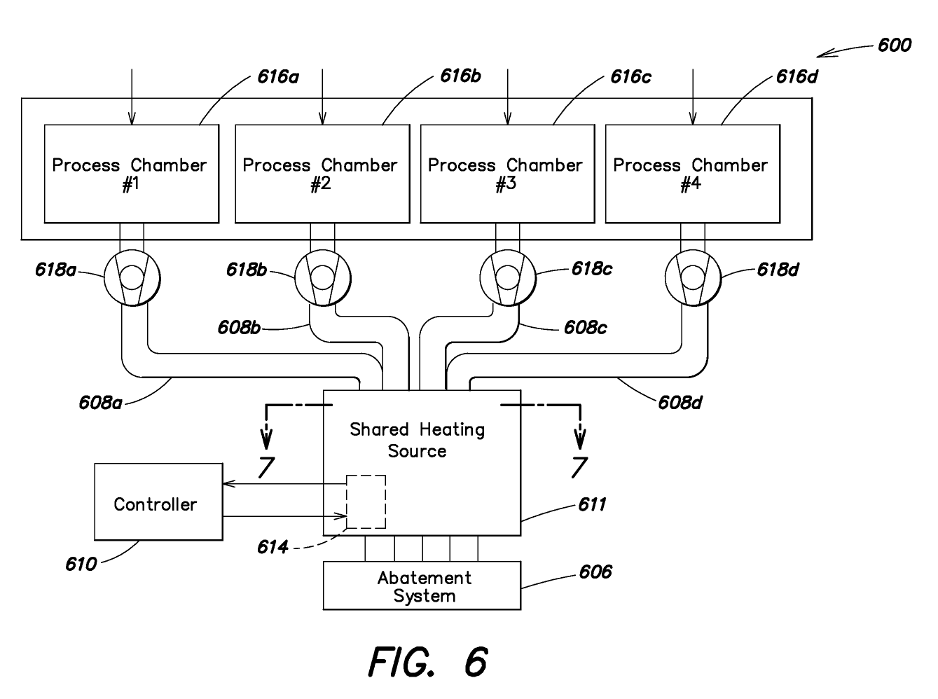

FIG. 6 is a schematic diagram of another exemplary embodiment of a system 600 of the present invention for conserving heat energy in electronic device manufacturing facilities. The system 600 may include one or more process tools 604 for manufacturing electronic devices, wherein the processes exhaust effluent from the one or more tools 604. The system 600 may further include one or more abatement systems 606 which may be adapted to abate effluent which has been exhausted from the one or more process tools 604. Effluent may flow and be carried from the one or more process tools 604 through effluent conduits 608 a-d to the one or more abatement systems 606. The one or more abatement systems 606 may be of any conventional construction. For example, the systems 606 may be adapted to abate the effluent (e.g., by burning or combustion) and/or by a point of use or house scrubber.

The abatement system 606 may be any system or unit that is adapted to abate the effluent from one or more process tools 604, such as the Marathon Abatement System available from Applied Materials, Inc. of Santa Clara, Calif.

The one or more process tools 604 may be a system that includes two or more process chambers 616a-d which exhaust the effluent that may be abated by the abatement system 606. For example, the one or more process tools 604 may include two or more deposition chambers, etching chambers, or any other process chambers which, during use, produce exhaust effluent susceptible to condensation and/or precipitation in the effluent conduits 608a-d components.

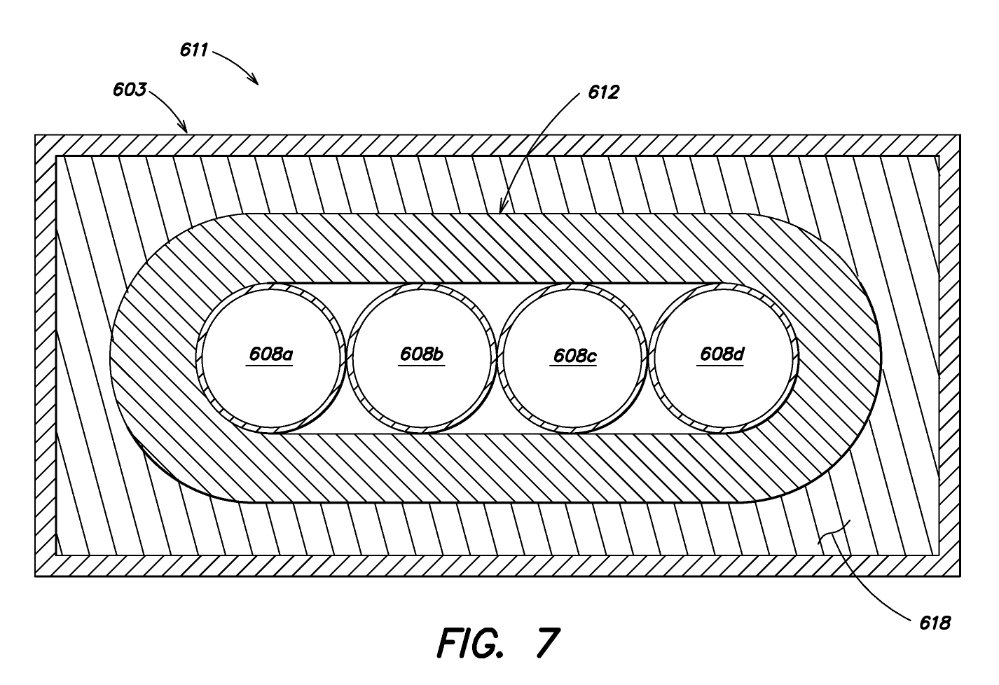

According to embodiments of the invention, a shared heating source 611 may be provided which includes one or more heating elements 612 (see FIG. 7). The heating source 611 may be provided as a shared heating source which may provide heat (via conduction and/or convection) to a plurality of effluent conduits 608a-d in an area where the conduits 208a-d are co-located (e.g., in contact with each other or in very close proximity to each other). The use of a shared heating source may enable common control as well as for sharing heat between the respective conduits 608a-d. In the depicted embodiment, the co-located portions of the effluent conduits 124 are located between the pumps 618a-d and the abatement system 606. However, the present invention may be utilized wherever any two or more of the conduits 608a-d may be co-located. For example, if any two or more of the conduits may be co-located upstream of the pumps 618a-d, then a shared heating source such as source 611 may be applied at that location. As in the previous embodiments, a controller 610 and one or more sensors 614 may be provided. Similarly, the one or more heating elements 612 (FIG. 7) may be controlled to a predetermined set point, for example, as described above.

A schematic depiction of the shared heating source 611 is shown in FIG. 7 which is a cross sectional view along a section line 7-7 shown in FIG. 6. The shared heating source 611 includes the co-located effluent conduits 608a-d in thermal engagement therewith. In the embodiment shown, four conduits 608a-d are shown co-located and in an in-line configuration. More co-located conduits, or as few as two co-located conduits, may be employed. Other configurations may be used as well, such as the configurations shown in FIG. 4. The heating element 612 may comprise one or more racetrack-shaped resistance heaters. Other configurations for the heater elements may be used as well, such as a plurality of hoop or ring heating elements surrounding each conduit.

The one or more heating elements 612 may be engaged in thermal contact with the conduits 608a-d. In the embodiment shown, the heating element 612 surrounds, and is in conductive thermal engagement with, the external surfaces of the conduits 608a-d in order to conductively heat them. Due to the co-location of the conduits 608a-d, however, they each may be thermally engaged convectively and/or radiatively also. In this manner, each conduit may be convectively and/or radiatively heated by the other conduits and/or other portions of the heating element 612 which may not be in direct conductive contact.

An insulating material 618 may be included which may at least partially radially surround the heating element 612 and conduits 608a-d. Such insulating material 618 may help contain the heat in the vicinity of the co-located conduits 608a-d. As in the previously described embodiments, the conduits 608a-d of the shared source 611 may be included in a channel 603 having a suitable shape such as rectangular, square, round, or oval. The insulating material 618 may be contained in the space between the heating element 612 and the channel 603 and extend along an entire length thereof. Any suitable insulating material may be used.

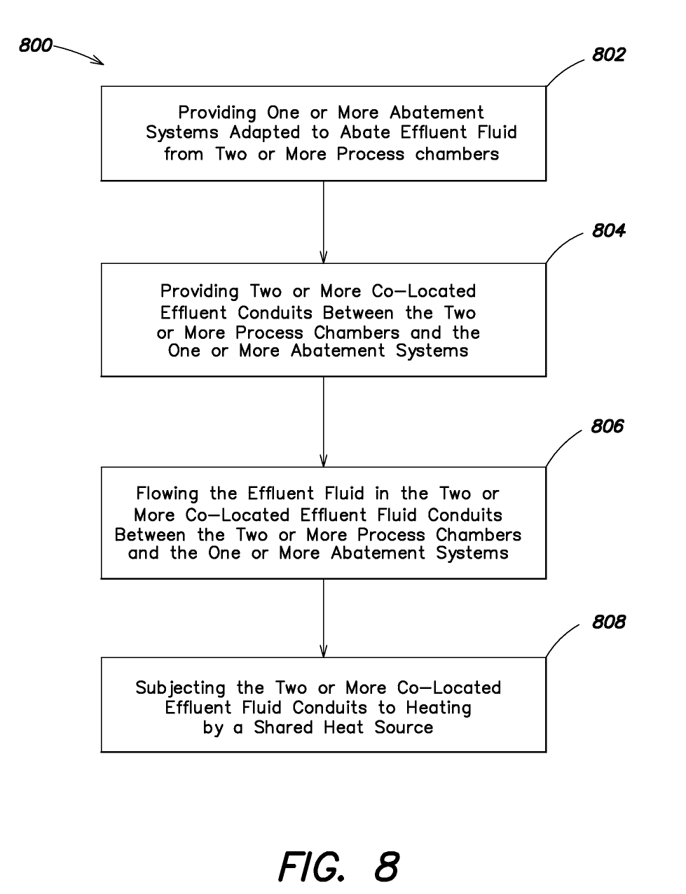

A method for conserving energy in an electronic device manufacturing facility according to the present invention is depicted in FIG. 8. The method 800 begins in step 802 and proceeds to step 804. According to step 802 of the method 800, one or more abatement systems are provided which are adapted to abate effluent fluid exhausted from two or more process chambers of one or more electronic device manufacturing process tools. The method includes step 804 where two or more co-located effluent conduits are provided and fluidly connected between the two or more chambers and the one or more abatements systems. At least one conduit is attached to each process chamber. Steps 802 and 804 may be performed in any order. The method also includes, in step 806, flowing the effluent fluid in the two or more co-located effluent conduits between the two or more process chambers and the one or more abatement systems. In step 808, the two or more co-located fluid conduits are subjected to heating by a shared heat source. Step 808 may take place during the step of flowing in step 806.

The foregoing description discloses only exemplary embodiments of the invention. Modifications of the above disclosed apparatus and methods which fall within the scope of the invention will be readily apparent to those of ordinary skill in the art. For example, the inventive channels may be used to house conduits elsewhere in the system, such as, for example, downstream of the abatement system. In some embodiments, the apparatus and methods of the present invention may be applied to semiconductor device processing and/or electronic device manufacturing.

Accordingly, while the present invention has been disclosed in connection with exemplary embodiments thereof, it should be understood that other embodiments may fall within the spirit and scope of the invention, as defined by the following claims.

1. An electronic device manufacturing system comprising:
one or more process chambers;
one or more abatement tools;
two or more effluent conduits connecting the one or more process chambers to the one or more abatement tools;
a channel adapted to house a portion of at least two of the two or more effluent conduits; and
one or more heating elements adapted to heat the two or more conduits within the channel.

2. The system of claim 1 further comprising one or more sensors adapted to sense a temperature within the channel.

3. The system of claim 2, further comprising a controller adapted to receive a signal from the one or more sensors, wherein the signal is related to the temperature within the channel.

4. The system of claim 3, wherein the controller is further adapted to determine whether the temperature within the channel is above a pre-determined temperature.

5. The system of claim 3, wherein the controller is further adapted to control the temperature in the channel based on the signal received from the one or more sensors.

6. The system of claim 5, wherein the controller controls the temperature in the channel by instructing the heaters to supply an amount of heat to the channel sufficient to maintain the temperature within the channel at or above the predetermined temperature.

7. The system of claim 4, wherein the predetermined temperature is a temperature that prevents condensation of the effluent in at least one of the two or more conduits.

8. The system of claim 4, wherein the predetermined temperature is a temperature that prevents precipitation of the effluent in at least one of the two or more conduits.

9. The system of claim 1, wherein the one or more heating elements are adapted to heat the two or more conduits via conduction.

10. The system of claim 1, wherein the one or more heating elements are adapted to heat the two or more conduits via convection.

11. A system adapted to conserve energy in an electronic device manufacturing facility comprising:
one or more processing tools adapted to process an electronic device;
one or more abatement systems adapted to abate effluent flowing from the one or more processing tools;
an apparatus adapted to couple the one or more processing tools to the one or more abatement systems, wherein the apparatus comprises:
two or more co-located effluent conduits carrying effluent fluid between the one or more abatement systems and the one or more processing tools; and
a shared heating source adapted to supply heat to the two or more co-located effluent conduits.

12. The system of claim 11 further comprising an insulation material surrounding at least a portion of a heating element of the shared heating source.

13. The system of claim 11 wherein the shared heating source comprises a heating element thermally engaging each of the co-located effluent conduits.

14. The system of claim 11 further comprising at least four co-located effluent conduits.

15. The system of claim 11 wherein the shared heating source comprises a heating element surrounding and contacting external surfaces of each of the two of more co-located effluent conduit.

16. The system of claim 15 wherein the heating element is at least partially surrounded by insulation and the heating element and the insulation are included within a channel.

17. The system of claim 11 wherein the shared heating source is located between one or more pumps which are adapted to pump the effluent and the one or more abatement systems.

18. A method for conserving energy in an electronic device manufacturing facility, comprising the steps of:
providing one or more abatement systems adapted to abate effluent fluid from two or more process chambers of one or more process tools;
providing two or more co-located effluent conduits between the two or more process chambers and the one or more abatement systems, with at least one effluent conduit being attached to each of the two or more process chambers; and
flowing the effluent fluid in the two or more co-located effluent conduits between the two or more process chambers and the one or more abatement systems; and
subjecting the two or more co-located effluent conduits to heating by a shared heat source.

19. The method of claim 18 further comprising the step of providing a controller and one or more sensors,
where the sensors are adapted to measure a temperature of the effluent fluid from at least one of the two or more process chambers; and
where the controller is adapted to:
receive signals from the sensors;
determine the difference between the temperature of the effluent fluid and a preselected temperature; and
control the shared heat source to reduce the difference between the temperature of the effluent fluid and the preselected temperature.
